(19) United States
(12) Patent Application Publication
(10) Pub. No.: US 2022/0108233 A1
(43) Pub. Date: Apr. 7, 2022

(54) BUILDING SPACE RESERVATION

(71) Applicant: Honeywell International Inc., Charlotte, NC (US)

(72) Inventors: Ananth Sozhan, Bangalore (IN); Mandar Tigga, Bangalore (IN); Roshan Lawrence Valder, Bangalore (IN); Manu Taranath, Bangalore (IN); Shouvik Brahma, Bangalore (IN); Anil Bondada, Bangalore (IN); Himanshu Khurana, Plymouth, MN (US); Sanjay Roy, Plymouth, MN (US); Aditya Arun, Bangalore (IN); Murugan Gopalan, Bangalore (IN)

(21) Appl. No.: 17/552,996

(22) Filed: Dec. 16, 2021

Related U.S. Application Data
(63) Continuation of application No. 16/059,718, filed on Aug. 9, 2018.

(51) Int. Cl. G06Q 10/02; H04W 4/33; G06Q 10/06

(52) U.S. Cl. CPC G06Q 10/02; G06Q 10/06311; H04W 4/33

(57) ABSTRACT

Methods, devices, and systems for building space reservation are described herein. In some examples, one or more embodiments include a display, a memory, and a processor to execute executable instructions stored in the memory to receive a reservation request including building space details for a building space in a building via the display, determine a building space in the building satisfying the building space details based on a location of a mobile device in the building, and reserve the determined building space.

### PRIORITY INFORMATION

This application is a continuation of U.S. application Ser. No. 16/059,718, filed Aug. 9, 2018, the contents of which are incorporated by reference.

### TECHNICAL FIELD

The present disclosure relates to methods, devices, and systems for building space reservation.

### BACKGROUND

Buildings can include different spaces for various uses. For example, an office can serve as a space where business of a professional, commercial, industrial, or other type of organization can be conducted, a conference room can serve as a space to meet with other people, (e.g., other team members or a client), etc.

Certain building spaces may be used for meeting with people. Such spaces may not always be in use. That is, they may not be assigned permanent occupants. As such, people may be able to reserve the space for different types of uses, such as, for example, a meeting space.

### BRIEF DESCRIPTION OF THE DRAWINGS

FIG. 1 is an example of a system for building space reservation, in accordance with one or more embodiments of the present disclosure.

FIG. 2 is an example of an illustration of a display provided on a user interface of a mobile device showing building space details, generated in accordance with one or more embodiments of the present disclosure.

FIG. 3 is an example of an illustration of a display provided on a user interface of a mobile device showing a building map, generated in accordance with one or more embodiments of the present disclosure.

FIG. 4 is an example of an illustration of a display provided on a user interface of a mobile device showing a building space selection, generated in accordance with one or more embodiments of the present disclosure.

FIG. 5 is an example of an illustration of a display provided on a user interface of a mobile device showing location-based building space reservation, generated in accordance with one or more embodiments of the present disclosure.

FIG. 6 is an example of a mobile device for building space reservation, in accordance with one or more embodiments of the present disclosure.

### DETAILED DESCRIPTION

Methods, devices, and systems for building space reservation are described herein. In some examples, one or more embodiments include a display, a memory, and a processor to execute executable instructions stored in the memory to receive a reservation request including building space details for a building space in a building via the display, determine a building space in the building satisfying the building space details based on a location of a mobile device in the building, and reserve the determined building space.

When reserving a building space in a building, a user may have knowledge of the building, including building space locations and/or building space availability. Further, the user may have access to tools to reserve the building space.

However, not all users who would like to reserve a building space may have knowledge of the building. For example, a user who would like to reserve a building space may be visiting the building temporarily or may be new to the building. As a result, reserving a building space may be a difficult task. For example, the user may not know that the building space may be only available for certain timeslots. In instances in which recurring meetings should be scheduled, the available timeslots may not align to reserve a recurring meeting.

For a user who may not be familiar with the building, reserving a building space can include other challenges. For example, the user may not have knowledge of building space locations available for reservation. Additionally, the user may not know about the availability of building spaces in the building.

In some examples, once the building space is reserved, the meeting may be canceled. For instance, time and/or scheduling conflicts for the user or other attendees to the meeting in the building space may arise such that the meeting should be canceled, but the building space reservation is not canceled. This situation can lead to a building space being reserved but not being used, resulting in reduced space utilization for spaces in a building.

In some examples, once a building space is reserved, the user may be able to meet with others in the building space. However, it may be difficult to extend the building space reservation if the meeting runs longer than the reserved timeslot of the building space. For example, the user may not know about the availability of the building space beyond the reserved timeslot.

Building space reservation, in accordance with the present disclosure, can provide a way to increase space utilization in spaces in a building in an efficient manner. Additionally, a user may not need to have knowledge of building space locations and/or building space availability in a building in order to reserve a building space in the building. Further, attendees of the meeting may not need knowledge of the building space to determine where the meeting is located, and when it is scheduled to occur. Accordingly, building space reservation in accordance with the present disclosure can be useful for those who are not familiar with the building.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

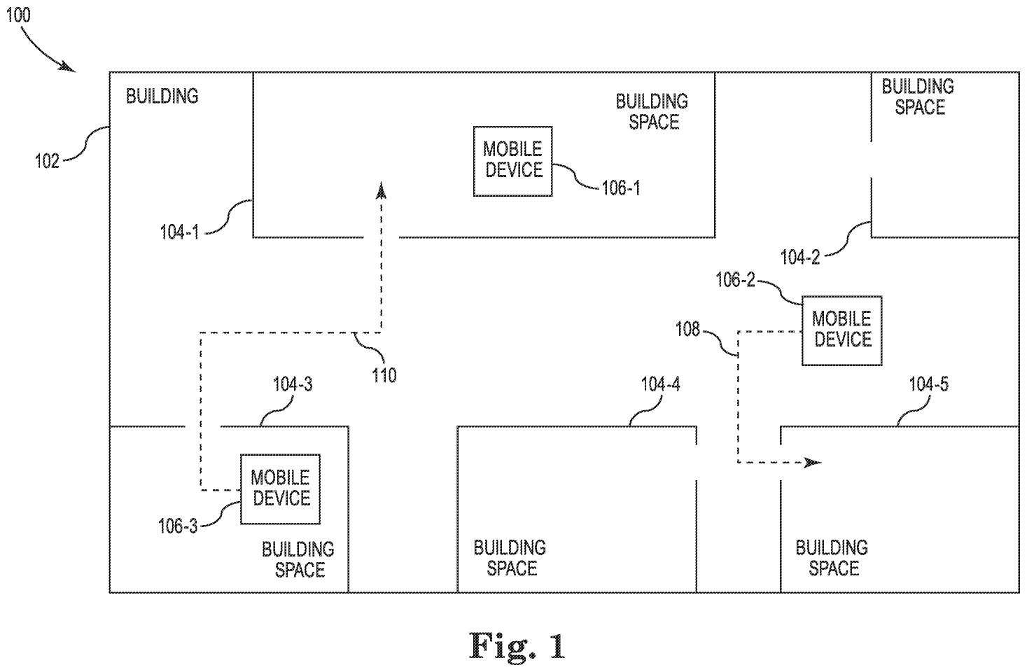

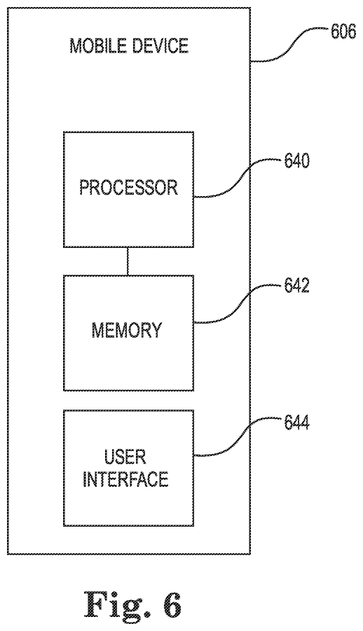

The figures herein follow a numbering convention in which the first digit or digits correspond to the drawing figure number and the remaining digits identify an element or component in the drawing. Similar elements or components between different figures may be identified by the use of similar digits. For example, 106 may reference element “06” in FIG. 1, and a similar element may be referenced as 606 in FIG. 6.

FIG. 1 is an example of a system 100 for building space reservation, in accordance with one or more embodiments of the present disclosure. As illustrated in FIG. 1, the system 100 can include building 102. Building 102 can include building spaces 104-1, 104-2, 104-3, 104-4, and 104-5 (referred to collectively as building spaces 104), mobile devices 106-1, 106-2, 106-3 (referred to collectively as mobile devices 106), directions 108, and directions 110. As used herein, a building space refers to a part of a building which may be separated by walls, doors, and/or other partitions from other parts of the building. For example, a building space may be an office or a room (e.g., a conference room).

Mobile devices 106 can receive a reservation request for a building space of building spaces 104 in building 102. For example, a user of mobile device 106-1 may want to reserve a particular (e.g., specific) building space, for instance, building space 104-1. For instance, the user may want to use building space 104-1 for a space to meet other people and to prevent other people, who for instance may not be invited to the meeting, from utilizing building space 104-1. As an additional example, the user may want to reserve a space, but not want to reserve a specific space and/or may not know which spaces can be reserved. The user of mobile device 106-1 can input a reservation request for a building space in building 102 via a display of mobile device 106-1, as is further described in connection with FIG. 6.

As used herein, a mobile device can include devices that are (or can be) carried and/or worn by a user. For example, mobile devices 106 can include a phone (e.g., a smart phone), a tablet, a personal digital assistant (PDA), smart glasses, and/or a wrist-worn device (e.g., a smart watch), among other types of mobile devices.

Although mobile devices 106 are described above as receiving a reservation request for a building space in a building via a display, embodiments of the present disclosure are not so limited. For example, a computing device can receive a reservation request for a building space 104 in building 102. A computing device can be, for example, a laptop computer, a desktop computer, or a mobile device, among other types of computing devices.

The reservation request received by mobile device 106-1 can include building space details for the building space in building 102. Building space details can include space preferences and/or itinerary information. Space preferences can include building space amenities such as an amount of seats in the building space, type of seating included in the building space, equipment included in the building space (e.g., whiteboard, projector, telephone, teleconference equipment, Internet access, television, flip charts, etc.), and/or a location of the building space, among other space preferences. For example, a user of mobile device 106-1 can input a reservation request including building space details including space preferences such as the location of the building space being on the same floor as the user of mobile device 106-1, the building space include at least three seats, and that the building space include equipment such as a whiteboard and a projector.

Itinerary information can include a timeslot of the building space 104, a date of the timeslot, and/or whether the reservation request is a recurring request, among other itinerary information. For example, a user of mobile device 106-1 can input a reservation request including building space details including itinerary information such as the timeslot be one hour, the timeslot be from 10:30 AM to 11:30 AM, and that the timeslot from 10:30 AM to 11:30 AM be on November 10^{th}.

In some examples, the timeslot can be a recurring reservation timeslot. For example, the user of mobile device 106-1 can input the reservation request for the one-hour timeslot from 10:30 AM to 11:30 AM on November 10^{th}, and that the timeslot be recurring once a week. However, embodiments of the present disclosure are not limited to recurring time slots of once a week. For example, a recurring timeslot can recur daily, weekly, monthly, bi-monthly, quarterly, yearly, etc.

Mobile device 106-1 can determine a building space 104 in building 102 satisfying the building space details based on a location of mobile device 106-1 in building 102. The location of mobile devices 106 in building 102 can be determined using beacons included in building 102. Although not illustrated in FIG. 1 for clarity and so as not to obscure embodiments of the present disclosure, building 102 may include a plurality of beacons associated with (e.g., located proximal to) different building spaces 104 of building 102.

The beacons can be devices capable of wireless communication with mobile devices 106 in building 102 and can allow for the determination of the location of the mobile devices 106 in building 102. For instance, the beacons can allow the determination of whether a mobile device 106-1 of a user is inside of, or within a particular (e.g., threshold) distance of the beacon and/or the space associated with the beacon. For example, the beacons can determine whether mobile device 106-1 is inside of building space 104-1. In another example, the beacons can determine whether mobile device 106-2 is inside of building space 104-5 or within a threshold distance of building space 104-5. The location of mobile devices 106 can be a real time location.

Although the location of mobile devices 106 inside building 102 is described above as being determined using beacons, embodiments of the present disclosure are not so limited. For example, other location determination systems can be used. For example, mobile devices 106 can be located inside building 102 via Bluetooth, cellular, Wi-Fi, radio frequency (RF), or other wireless communication system that can determine the location of mobile devices 106 within building 102 (e.g., by collecting real time location data of mobile devices 106 in building 102).

As described above, the mobile device (e.g., mobile device 106-1) can determine a building space 104 in building 102 satisfying the building space details based on the location of the mobile device 106-1 in the building. For example, mobile device 106-1 can utilize the building space details, including the space preferences (e.g., the location of the building space be on the same floor as the user of mobile device 106-1, the building space include at least three seats, and that the building space include equipment such as a whiteboard and a projector) and the itinerary information (e.g., the timeslot be one hour, the timeslot be from 10:30 AM to 11:30 AM, and that the timeslot from 10:30 AM to 11:30 AM be on November 10^{th}) to generate a list of building spaces satisfying the above building space details.

For example, mobile device 106-1 can determine that building spaces 104-1, 104-2, 104-4, and 104-5 satisfy the above building space details (e.g., building spaces 104-1, 104-2, 104-4, and 104-5 are each on the same floor as the user of mobile device 106-1, include at least three seats, include at least a whiteboard and a projector, and have an available one-hour time slot on November 10^{th} from 10:30 AM to 11:30 AM). Additionally, mobile device 106-1 can determine that building spaces 104-1, 104-2, and 104-4 are a distance from mobile device 106-1 that is within a threshold distance away from mobile device 106-1 (e.g., based on the location of mobile device 106-1 in building 102 that is determined by the beacons included in building 102).

Mobile device 106-1 can display the location of the determined building space(s) 104 in building 102 via a display of mobile device 106-1. For example, mobile device 106-1 can include a display that can display a map of building 102. The display can display building spaces 104-1, 104-2, and 104-4 on the map of building 102 as building spaces that satisfy the building space details included in the reservation request received by mobile device 106-1.

The building spaces that satisfy the building space details can be displayed on the map in different ways. In some examples, building spaces 104-1, 104-2, and 104-4 can be indicated on the map via an icon that indicates the building spaces satisfy the building space details. In some examples, building spaces 104-1, 104-2, and 104-4 can include a distinctive marking, such as a glowing or flashing border surrounding building spaces 104-1, 104-2, and 104-4 on the map. In some examples, building spaces 104-1, 104-2, and 104-4 can be colored, and other building spaces which do not satisfy the building space details can be greyed out.

Although building spaces 104-1, 104-2, and 104-4 are described above as being indicated on the map on the display of mobile device 106-1 as having an icon, distinctive marking, and/or colored, embodiments of the present disclosure are not so limited. For example, building spaces 104-1, 104-2, and 104-4 that satisfy the building space details can be displayed on the map in any other manner in order to indicate building spaces 104-1, 104-2, and 104-4 satisfy the building space details.

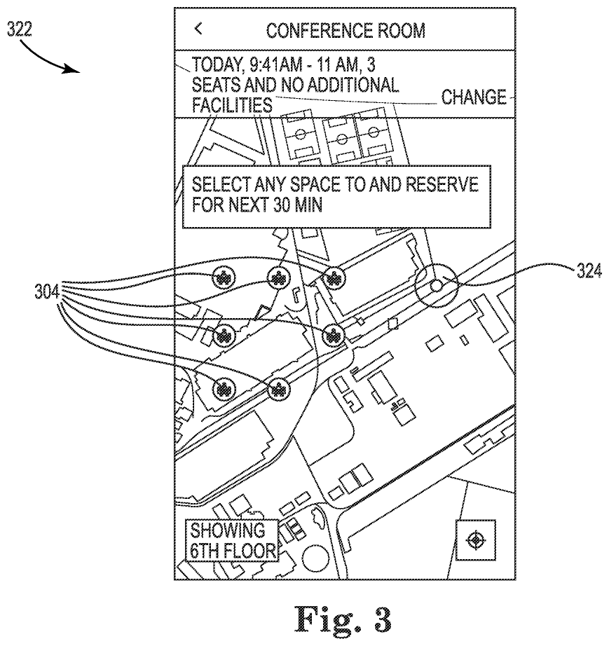

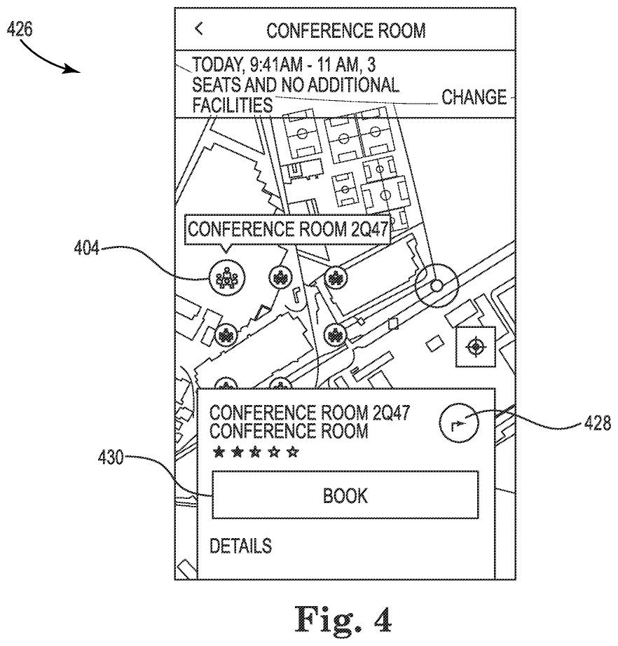

Mobile device 106-1 can reserve the determined building space(s) 104. For example, mobile device 106-1 can reserve one of the determined building spaces 104 that satisfy the building space details. For example, a user can select the particular building space 104 they want to reserve that satisfies the building space details (e.g., the building space 104 is on the same floor as the user of mobile device 106-1, includes at least three seats, includes at least a whiteboard and a projector, and has an available one-hour time slot on November 10^{th} from 10:30 AM to 11:30 AM) in response to a user selection of the building space 104. For instance, the user of mobile device 106-1 can select building space 104-1 via the display of mobile device 106-1 in order to reserve building space 104-1 for the one-hour time slot on November 10^{th} from 10:30 AM to 11:30 AM. The user of mobile device 106-1 can select building space 104-1 via a selection from the map on mobile device 106-1 that is displaying building spaces 104-1, 104-4, and 104-5, as is further described in connection with FIGS. 3 and 4.

As described above, in some examples the reservation request can be a recurring request. For example, the user of mobile device 106-1 can input the reservation request for a weekly recurring one-hour timeslot from 10:30 AM to 11:30 AM, and the building spaces that satisfy the building space details including the recurring request can be building spaces 104-1, 104-4, and 104-5.

Mobile device 106-1 can reserve the determined building space 104 (e.g., building space 104-1) for the recurring reservation timeslot in response to building space 104 satisfying the building space details for a number of occurrences of the recurring reservation timeslot. For example, in response to building space 104-1 satisfying the number of occurrences of the recurring reservation timeslot (e.g., 10:30 AM to 11:30 AM weekly recurring timeslot), mobile device 106-1 can reserve building space 104-1 for the weekly recurring timeslot based on the user selecting building space 104-1 (e.g., via the display of mobile device 106-1).

In some examples, a user of a mobile device 106 can be located in a building space 104 the user may wish to reserve. For example, the user of mobile device 106-1 may move to building space 104-1 in order to reserve building space 104-1. Mobile device 106-1 can prompt the user to reserve building space 104-1 in response to the building space 104-1 satisfying the building space details, and the location of mobile device 106-1 in building 102 being the same as the location of building space 104-1 in building 102. For example, as previously described above, beacons included in building 102 can determine that the location of mobile device 106-1 and the location of building space 104-1 is the same.

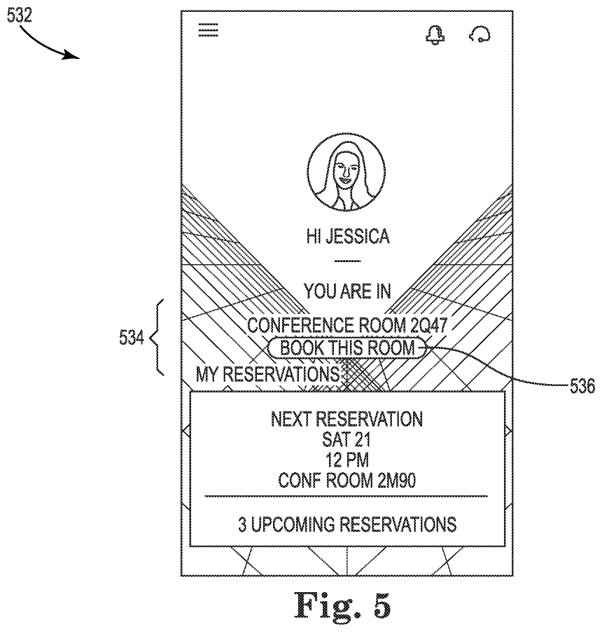

Based on this determination, mobile device 106-1 can prompt the user of mobile device 106-1 to reserve building space 104-1. Mobile device 106-1 can reserve building space 104-1 in response to the user of mobile device 106-1 accepting the prompt to reserve building space 104-1, as is further described herein with respect to FIG. 5.

As described above, some users may not have knowledge of building 102. For example, the user of mobile device 106-2 may have reserved building space 104-5 for use. However, it may be their first time in the building and the user of mobile device 106-2 may not know the layout of the building and/or how to navigate to a reserved building space 104-5.

The display of mobile device 106-2 can display directions 108 from the location of mobile device 106-2 in building 102 to the location of the reserved building space 104-5. For example, as described above, the display of mobile device 106-2 can display a map of building 102, and directions 108 can be overlaid on the map displayed on the display of mobile device 106-2. The directions 108 can direct a user of mobile device 106-2 from their current location (e.g., in a hallway outside of building space 104-5 as illustrated in FIG. 1) to the location of building space 104-5.

In some examples, the directions can be turn-by-turn directions. For example, the directions can instruct the user of mobile device 106-2 to walk to the left (e.g., as oriented in FIG. 1), turn and walk downwards, and again turn to the left to walk into building space 104-5, and can update in real time as the user of mobile device 106-2 moves in building 102. The turn-by-turn directions can be displayed on the map on the display of mobile device 106-2. In some examples, the turn-by-turn directions can be audible instructions emitted by an audio output device (e.g., a speaker) of mobile device 106-2.

In an example in which mobile device 106-1 reserves building space 104-1 for a meeting, the user of mobile device 106-1 may want to meet with another user in building space 104-1. In such a case, mobile device 106-1 can transmit the location of the determined building space 104-1 and the building space details to other mobile devices. For example, mobile device 106-1 can transmit the location of reserved building space 104-1 and the building space details (e.g., the building space is building space 104-1, includes at least three seats, includes at least a whiteboard and a projector, and is reserved for a one-hour time slot on November 10^{th} from 10:30 AM to 11:30 AM) to mobile device 106-3 so that the user of mobile device 106-3 knows where and when to meet the user of mobile device 106-1 (e.g., building space 104-1 at 10:30 AM on November 10^{th}.

Although mobile device 106-1 is described above as transmitting the location of the determined building space 104 and the building space details to one other mobile device, embodiments of the present disclosure are not so limited. For example, mobile device 106-1 can transmit the location of the determined building space and the building space details to any other number of mobile devices (e.g., two or more mobile devices).

Mobile device 106-1 can transmit the location of the determined building space 104-1 and the building space details to other mobile devices via a network relationship. For example, mobile device 106-1 can transmit the location of the determined building space 104-1 and the building space details to other mobile devices via a wired or wireless network.

The wired or wireless connection can be a network relationship that connects mobile devices 106 to each other. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, and/or the Internet, among other types of network relationships.

Once transmitted, the users of other mobile devices can know the location of the reserved building space (e.g., building space 104-1). The other mobile devices can display directions from their locations to the reserved building space 104 in building 102. For example, mobile device 106-1 can transmit the location of building space 104-1 to mobile device 106-3.

The display of mobile device 106-3 can display directions 110 from the location of mobile device 106-3 in building 102 (e.g., building space 104-3) to the location of the reserved building space 104-1. For example, the display of mobile device 106-3 can display a map of building 102, and directions 110 can be overlaid on the map displayed on the display of mobile device 106-3. The directions 110 can direct a user of mobile device 106-3 from their current location (e.g., in building space 104-3 as illustrated in FIG. 1) to the location of building space 104-1.

As previously described above, the directions can be turn-by-turn directions. For example, the directions can instruct the user of mobile device 106-3 to walk to the left (e.g., as oriented in FIG. 1), turn and walk upwards, turn to walk to the right, and turn to the left to walk upwards into building space 104-1. The directions can update in real time as the user of mobile device 106-3 moves in building 102. The turn-by-turn directions can be displayed on the map on the display of mobile device 106-3. In some examples, the turn-by-turn directions can be audible instructions emitted by an audio output device (e.g., a speaker) of mobile device 106-3.

Once a building space 104 is reserved, the building space 104 is unable to be reserved by mobile devices of other users. However, in some instances, an event in the reserved building space may not take place. For example, the user of a mobile device 106 may have had a scheduling conflict arise and is unable to meet in a building space 104 on November 10^{th} from 10:30 AM to 11:30 AM (e.g., a reserved timeslot of a building space 104).

Mobile device 106 can cancel the reserved building space 104 in response to the location of mobile device 106 and the location of building space 104 being different when a reserved timeslot of the building space begins. For example, mobile device 106-1 may have reserved building space 104-4 from 10:30 AM to 11:30 AM on November 10^{th}. If, on November 10^{th}, mobile device 106-1 is located in building space 104-1 at 10:30 AM (e.g., because the user of mobile device 106-1 is unable to meet and utilize reserved building space 104-4 for the reserved timeslot of 10:30 AM to 11:30 AM), mobile device 106-1 can determine that the location of mobile device 106-1 (e.g., utilizing beacons) is not the same as the location of building space 104-4. As a result, mobile device 106-1 can cancel the reserved building space 104-4. In other words, mobile device 106-1 can automatically cancel the reserved building space 104-4 if mobile device 106-1 is not in the reserved building space 104-4 at the time the reserved timeslot begins.

Although mobile device 106 is described above as canceling the reserved building space 104 in response to the location of mobile device 106 and the location of building space 104 not being the same at the moment the reserved timeslot begins, embodiments of the present disclosure are not so limited. For example, mobile device 106 can refrain from automatically canceling the reserved building space 104 fora predetermined amount of time (e.g., 5 minutes, 10 minutes, etc.) if mobile device 106 is not in the reserved building space 104 at the time the reserved timeslot begins, but automatically cancel the reserved building space 104 after the expiration of the predetermined amount of time. In some examples, mobile device 106 can prompt the user before canceling the reserved building space 104, as is further described herein.

Mobile device 106 can prompt a user to modify the reserved building space 104 in response to the location of mobile device 106 and the location of building space 104 being different when a reserved timeslot of the building space begins. For example, mobile device 106-1 may have reserved building space 104-4 from 10:30 AM to 11:30 AM on November 10^{th}. If, on November 10^{th}, mobile device 106-1 is located in building space 104-1 at 10:30 AM (e.g., because the user of mobile device 106-1 is unable to meet or is late arriving to reserved building space 104-4), mobile device 106-1 can prompt the user to modify the reserved building space 104-4.

Modifying the reserved building space can include, in some examples, modifying the reserved timeslot of the building space 104. For example, mobile device 106-1 can prompt the user to modify the reserved timeslot to a different start time (e.g., 10:45 AM, 11:00 AM, etc.), and can modify the start time of the reserved timeslot accordingly via an input from the user. In some examples, modifying the reserved building space timeslot can include canceling, via an input from the user, the reserved timeslot of building space 104.

In some examples, mobile device 106 can cancel the reserved building space in response to a user input not being received within a threshold amount of time. For example, mobile device 106-1 can prompt the user to modify the reserved building space 104-4. In response to the user not modifying the reserved building space 104-4 within five minutes (e.g., no user input is received by mobile device 106-1 within five minutes), mobile device 106-1 can automatically cancel the reserved building space 104-4.

Canceling reserved building spaces 104 in such a manner can prevent building spaces from going unused. This can increase building space availability and building space utilizing in building 102.

The user of mobile device 106 can utilize building space 104 for a meeting space, among other uses, when building space 104 is reserved. In some instances, meetings may run long and exceed a reserved timeslot of a building space 104. For example, the user of mobile device 106-1 may conduct a meeting in building space 104-1 from 10:30 AM to 11:30 AM. The meeting may run long and as a result, may have to extend beyond 11:30 AM. In such an example, mobile device 106-1 can extend the reserved timeslot.

Mobile device 106-1 can extend the reserved timeslot in response to an amount of time remaining on the reserved time slot is less than a threshold amount of time and the building space 104 is not reserved for a subsequent time slot after the reserved time slot. For example, mobile device 106-1 can prompt a user if an amount of time remaining in the reserved time slot (e.g., four minutes) is less than a threshold amount of time (e.g., five minutes) and the building space 104-1 is not reserved after 11:30 AM. For example, mobile device 106-1 can prompt the user at 11:26 to extend the reserved time slot beyond 11:30 AM if building space 104-1 is not reserved by another user after 11:30 AM. In response to a user input, mobile device 106-1 can extend the reserved time slot. In some examples, mobile device 106 can extend the reserved time slot by a predetermined amount of time (e.g., ten minutes, fifteen minutes, thirty minutes, etc.). In some examples, mobile device 106 can extend the reserved time slot by a user specified amount of time.

In some instances, the building space 104 may be reserved by another user for the subsequent time slot after the reserved time slot. In such a case, mobile device 106 can display different building spaces 104 satisfying revised building space details in response to the building space 104 being reserved for the subsequent time slot. For example, building space 104-1 may be reserved after 11:30 AM. In response, mobile device 106-1 can display building spaces 104-2, 104-4 that satisfy revised building space details (e.g., the building space is on the same floor as the user of mobile device 106-1, includes at least three seats, includes at least a whiteboard and a projector, and has an available time slot on November 10^{th} at 11:30 AM). In other words, the revised building space details can include the same building space details as before, but with a different time slot. In response to a user selecting a revised building space 104 (e.g., building space 104-2), mobile device 106-1 can reserve the building space 104-2 to continue and/or finish the meeting.

Building space reservation, according to the present disclosure, can allow for seamless and efficient reservation of building spaces in a building using a mobile device. The user of the mobile device can reserve building spaces without having prior knowledge of the building including the location and/or other details of building spaces, allowing the user to find suitable building spaces as well as navigate to those suitable building spaces. Other users who may come to the reserved building space during the reserved timeslot may also not need prior knowledge of the building including the building spaces. Further, building space reservation can allow for the cancelation of unused building spaces, increasing space utilization in the building.

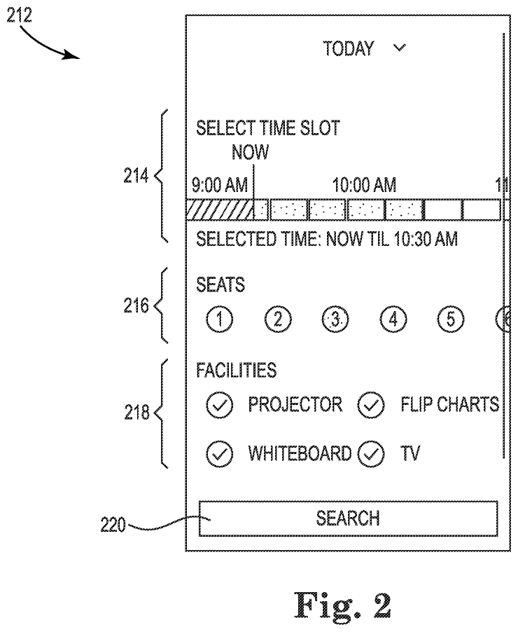

FIG. 2 is an example of an illustration of a display provided on a user interface of a mobile device showing building space details 212, generated in accordance with one or more embodiments of the present disclosure. As illustrated in FIG. 2, building space details 212 can include time slot 214, seats 216, equipment 218, and search function 220.

Building space details can include space preferences. Space preferences can include building space amenities. For example, a user of a mobile device can specify an amount of seats 216 (e.g., three seats, as illustrated in FIG. 2), and whether the user would like certain equipment 218 to be included in the building space, such as projectors, whiteboards, flip charts, TV, etc.

Building space details can also include itinerary information. Itinerary information can include a timeslot 214 of the building space, a date of the timeslot, and/or whether the reservation request is a recurring request, among other itinerary information. For example, a user of the mobile device can specify a time slot 214 to be from the current time (e.g., 9:41 AM) to 11 AM.

Once a user has specified space preferences and itinerary information, the user can search for building spaces by utilizing search function 220. For example, the user can search utilizing search function 220 for building spaces that meet the specified building space details in order to make a reservation request for a building space.

FIG. 3 is an example of an illustration of a display provided on a user interface of a mobile device showing a building map 322, generated in accordance with one or more embodiments of the present disclosure. As illustrated in FIG. 3, building map 322 can include mobile device location 324 and building spaces 304.

As illustrated in FIG. 3, the mobile device can determine building spaces 304 that satisfy building space details. The building spaces 304 that satisfy the building space details are displayed on the building map 322 of the display of the mobile device.

The mobile device location 324 can be displayed on building map 322. For example, mobile device location 324 can be the current location of the mobile device in the building having building spaces 304. The mobile device location 324 can be a real time location determined by beacons included in the building.

Building map 322 can additionally show a summary of the specified building space details. For example, the building space detail summary can include the reservation timeslot (e.g., 9:41 AM to 11 AM), as well as a specified number of seats (three seats). Building map 322 can prompt a user to select a building space 304 to reserve for the reservation timeslot.

FIG. 4 is an example of an illustration of a display provided on a user interface of a mobile device showing a building space selection 426, generated in accordance with one or more embodiments of the present disclosure. As illustrated in FIG. 4, building space selection 426 can include a selected building space 404, directions 428, and reserve function (e.g., button) 430.

As illustrated in FIG. 4, a user has selected building space 404. Building space 404 can be a conference room (e.g., Conference Room 2Q47) located in the building that satisfies the building space details (e.g., has an open time slot from 9:41 AM to 11 AM and includes three seats).

The building map can show conference room details. Further, the building space can include a rating. For example, as illustrated in FIG. 4, building space 404 can include a two-and-a-half-star rating.

The display can include directions 428. For example, a user can select directions 428 and turn-by-turn directions can be displayed on the map. The turn-by-turn directions can guide a user of the mobile device from their current location to the location of selected building space 404.

The user of the mobile device can reserve selected building space 404 by selecting reserve function 430. For example, a user can input a selection of building space 404 to reserve building space 404 by selecting reserve function 430.

FIG. 5 is an example of an illustration of a display provided on a user interface of a mobile device showing location-based building space reservation 532, generated in accordance with one or more embodiments of the present disclosure. As illustrated in FIG. 5, location-based building space reservation 532 can include mobile device location 534 and reserve function 536.

As previously described in connection with FIG. 1, a user of a mobile device can be located in a building space the user may wish to reserve. For example, the user of the mobile device may be located in Conference Room 2Q47. That is, the mobile device location 534 of the mobile device can be in the building space the user of the mobile device wishes to reserve.

The mobile device can prompt the user to reserve the building space (e.g., Conference Room 2Q47) in response to the building space satisfying the building space details and the mobile device location 534 being the same as the location of the building space. For example, as illustrated in FIG. 5, the mobile device can allow the user to utilize reserve function 536 to reserve the building space as a result of the mobile device location 534 being the same as the location of the building space.

FIG. 6 is an example of a mobile device 606 for building space reservation, in accordance with one or more embodiments of the present disclosure. As illustrated in FIG. 6, mobile device 606 can include a user interface 644, memory 642 and a processor 640 for building space reservation in accordance with the present disclosure.

Mobile device 606 can be any of mobile devices 106 previously described in connection with FIG. 1. Mobile device 606 can be, for example, a laptop computer, a smart phone, tablet, personal digital assistant, smart glasses, a wrist-worn device, etc., and/or redundant combinations thereof, among other types of mobile devices.

The memory 642 can be any type of storage medium that can be accessed by the processor 640 to perform various examples of the present disclosure. For example, the memory 642 can be a non-transitory computer readable medium having computer readable instructions (e.g., computer program instructions) stored thereon that are executable by the processor 640 for building space reservation in accordance with the present disclosure.

The memory 642 can be volatile or nonvolatile memory. The memory 642 can also be removable (e.g., portable) memory, or non-removable (e.g., internal) memory. For example, the memory 642 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 642 is illustrated as being located within mobile device 606, embodiments of the present disclosure are not so limited. For example, memory 642 can also be located internal to another computing resource (e.g., enabling computer readable instructions to be downloaded over the Internet or another wired or wireless connection).

As illustrated in FIG. 6, mobile device 606 includes user interface 644. In some examples, the user interface 644 of mobile device 606 can display building space details (e.g., as previously described in connection with FIG. 2), a building map (e.g., as previously described in connection with FIG. 3), a building space selection (e.g., as previously described in connection with FIG. 4), and/or a location-based building space reservation (e.g., as previously described in connection with FIG. 5), etc. A user (e.g., operator) of mobile device 606 can interact with mobile device 606 via user interface 644. For example, user interface 644 can provide (e.g., display and/or present) information to the user of mobile device 606, and/or receive information from (e.g., input by) the user of mobile device 606. For instance, in some embodiments, user interface 644 can be a graphical user interface (GUI) that can provide and/or receive information to and/or from the user of mobile device 606, respectively. The display can be, for instance, a touch-screen (e.g., the GUI can include touch-screen capabilities). Alternatively, a display can include a television, computer monitor, mobile device screen, other type of display device, or any combination thereof, connected to mobile device 606 and configured to receive a video signal output from mobile device 606.

User interface 644 can be localized to any language. For example, user interface 644 can display building space reservation in any language, such as English, Spanish, German, French, Mandarin, Arabic, Japanese, Hindi, etc.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

1.-20. (canceled)

21. A method for building space reservation, comprising:
receiving, by a mobile device, a reservation request for reserving a building space in a building from a user, wherein the reservation request includes space preferences and itinerary information;
determining a list of building spaces based on the space preferences, the itinerary information, and a real-time location of the mobile device;
rendering, on a map interface on a display of the mobile device, the list of building spaces, wherein the building spaces include a distinctive marking on the map interface; and
executing a reservation of a building space from the list of building spaces on the map interface in response to a user input to the display of the mobile device.

22. The method of claim 21, wherein the method includes transmitting, by the mobile device, a location of the building space, the space preferences, and the itinerary information to a number of other mobile devices.

23. The method of claim 21, wherein the method includes displaying directions on the map interface that directs a user of the mobile device from the real-time location of the mobile device to a location of the reserved building space.

24. The method of claim 21, wherein the method includes displaying, on the display of the mobile device, an additional list of building spaces in response to the building space being reserved for a subsequent time slot.

25. The method of claim 21, wherein the method includes prompting a user of the mobile device to modify the reservation of the building space in response to the real-time location of the mobile device and a location of the reserved building space being different when a start time of the reservation begins.

26. The method of claim 25, wherein the method includes cancelling the reservation of the building space in response to the real-time location of the mobile device and the location of the reserved building space being different when the start time of the reservation begins.

27. The method of claim 21, wherein:
the reservation request includes building space details for a recurring reservation time slot; and
the method includes executing the reservation of the building space for the recurring reservation time slot in response to the building space satisfying the building space details for a number of occurrences of the recurring reservation time slot.

28. The method of claim 21, wherein the method includes extending, by the mobile device, a time slot of the reservation of the building space in response to an amount of time remaining on the time slot being less than a threshold amount of time and the building space not being reserved for a subsequent time slot after the time slot.

29. The method of claim 21, wherein the method includes determining the real-time location of the mobile device using wireless communication devices in the building.

30. A non-transitory computer readable medium having computer readable instructions stored thereon that are executable by a processor to:
receive a reservation request for reserving a building space in a building from a user, wherein the reservation request includes space preferences and itinerary information;
determine a list of building spaces based on the space preferences, the itinerary information, and a real-time location of a mobile device;
render, on a map interface on a display, the list of building spaces, wherein the list of building spaces include a distinctive marking on the map interface; and
execute a reservation of a building space from the list of building spaces on the map interface in response to a user input to the display.

31. The computer readable medium of claim 30, wherein the computer readable instructions are executable by the processor to determine the list of the building spaces by selecting building spaces that are within a threshold distance of the real-time location of the mobile device.

32. The computer readable medium of claim 30, wherein the computer readable instructions are executable by the processor to determine the list of the building spaces by selecting building spaces that satisfy the space preferences and the itinerary information.

33. The computer readable medium of claim 30, wherein the distinctive marking comprises a flashing border surrounding the building spaces on the map interface.

34. The computer readable medium of claim 30, wherein the computer readable instructions are executable by the processor to:
prompt a user to reserve the building space from the list in response to a location of the building space being the same as the real-time location of the mobile device and the building space satisfying the space preferences and the itinerary information; and
execute the reservation of the building space in response to receiving an input from the user.

35. A system for building space reservation, comprising:
a number of wireless communication devices; and
a mobile device, wherein the mobile device is configured to:
receive a reservation request for reserving a building space in a building from a user, wherein the reservation request includes space preferences and itinerary information;
determine a list of building spaces based on the space preferences, the itinerary information, and a real-time location of the mobile device, wherein the real-time location of the mobile device is determined utilizing the number of wireless communication devices;
render, on a map interface on a display of the mobile device, the list of building spaces, wherein the building spaces include a distinctive marking on the map interface; and
execute a reservation of a building space from the list of building spaces on the map interface in response to a user input to the display of the mobile device.

36. The system of claim 35, wherein the space preferences include a type of seating included in a building space, an amount of seats included in a building space, equipment included in a building space, and a location of the building space.

37. The system of claim 36, wherein the equipment included in a building space includes at least one of teleconference equipment, Internet access, a television, a projector, and a whiteboard.

38. The system of claim 35, wherein the itinerary information includes at least one of a time slot, a date, and whether the reservation request is a recurring reservation request.

39. The system of claim 35, wherein:
the system includes an additional mobile device; and
the mobile device is configured to transmit a location of the reserved building space and building space details associated with the reserved building space to the additional mobile device.

40. The system of claim 39, wherein the additional mobile device is configured to display directions that direct a user of the additional mobile device from a real-time location of the additional mobile device to the location of the reserved building space.
